(19) United States
(12) Patent Application Publication
(10) Pub. No.: US 2009/0150463 A1
(43) Pub. Date: Jun. 11, 2009

(54) METHOD OF MIGRATION BETWEEN VIRTUAL MACHINE AND PHYSICAL MACHINE AND MACHINE SYSTEM THEREOF

(76) Inventors: TOMOKI SEKIGUCHI, SAGAMIHARA (JP); HIDETOSHI SATO, EBINA (JP); TAISEI YOSHINO, MACHIDA (JP)

Correspondence Address: MATTINGLY & MALUR, P.C., 1800 DIAGONAL ROAD, SUITE 370, ALEXANDRIA, VA, 22314, US

(21) Appl. No.: 12/165,887

(22) Filed: Jul. 1, 2008

(30) Foreign Application Priority Data
Dec. 11, 2007 (JP) 2007-319340

(51) Int. Cl. G06F 17/30

(52) U.S. Cl. 707/204; 707/E17.001

(57) ABSTRACT

One of a first computer and a second computer has a virtualization module and the other one does not have a virtualization module. In response to a migration instruction, an OS in execution on the first computer is suspended. The contents of a memory area of the first computer used for the OS at the suspend point are migrated to a memory area of the second computer. In this migration, a storage area of information indicative of the OS suspend point is included. A memory area management method between the first computer and the second computer is converted. Then, the second computer resumes OS execution by referring to the information indicative of the suspend point and using the migrated contents of the memory area.

The present application claims priority from Japanese application serial no. JP2007-319340, filed on Dec. 11, 2007, the content of which is hereby incorporated by reference into this application.

### BACKGROUND OF THE INVENTION

The present invention relates to a method of OS migration between a computer which executes a guest OS by a virtualization technology or a logical partitioning technology and a physical computer which does not implement these technologies and a computer system thereof.

A technology for configuring a virtual machine on one computer and concurrently executing a plurality of operating systems (OS) is coming into wide use. There are a virtual machine method and a logical partition method as technologies for achieving this. A computer to which these technologies are applied is referred to as a computer having a virtualization module. An OS executed under the virtualization module is referred to as a guest OS.

In the virtual machine method, control software called a virtual machine monitor (VMM) virtualizes registers for controlling the operation of a processor and the hardware of a computer to configure a plurality of virtual machines (VM). A guest OS executes on a VM configured by the VMM. More specifically, the VMM traps and emulates a privileged instruction such as a control register operation and an input/output (I/O) instruction executed by the guest OS to create a virtual machine environment. In the virtual machine method, a plurality of guest OSs can share one physical I/O device. This is because access to a virtual I/O device seen from the guest OS by the VMM is trapped and converted (emulated) into access to an actual physical I/O device. Thereby, it is possible to achieve a flexible virtual machine environment that depends little on the I/O device incorporated in the computer.

In the I/O control of the virtual machine method, the VMM emulates an I/O operation by the guest OS, so that overhead occurs. Further, the VMM of the virtual machine emulates I/O operations by the other guest OSs which are executed concurrently, so that the overhead depends on processing by the other guest OSs; therefore, there is a problem that it is difficult to predict the performance.

On the other hand, in the logical partition method, control software called a hypervisor logically partitions the resources of a computer to configure a plurality of machines. The hypervisor operates tables and registers referred to by the processor and the other hardware to logically partition the computer. A guest OS executes in a partition formed by being logically partitioned by the hypervisor. This partition is referred to as a logical partition (LPAR). A privileged instruction executed by the guest OS, particularly an I/O instruction is directly executed by the processor without being emulated. For this reason, the guest OS is hardly affected by another guest OS executed in the same computer, thus enabling a high-performance and high-reliability virtual machine environment. On the other hand, in the logical partition method, since a plurality of LPARs are formed by partitioning the hardware resources, an I/O device cannot be shared by a plurality of guest OSs. In order to share the I/O device among the guest OSs in the logical partition method, handling for sharing is required for the device.

As described, a virtual machine where the guest OS executes is configured by the emulation of a privileged instruction in the virtual machine method or by the partition of the computer by hypervisor in the logical partition method.

These technologies are conventionally achieved mainly by a large scale computer called a mainframe. This is because achieving these technologies with high performance has required special hardware such as a processor suitable for the virtual machine method and a module for performing the emulation processing of the VMM by hardware. However, due to recent performance improvements in processors and the intake of the virtualization module, sufficient performance can be obtained even if these processes are performed by a processor; accordingly, the virtual machine method and the logical partition method are becoming widespread in ordinary computers as well as the mainframe. Hereinafter, the virtual machine method and the logical partition method may be collectively referred to as a virtual machine method.

The virtual machine method has a characteristic that a VM defined on a computer can be migrated and executed on another computer where a VMM is executed. This is called the migration of the VM. It is also possible to migrate the VM to another computer without suspending the VM in operation. If the VMM in the computer of a migration destination can emulate, as originally defined, an I/O device required by the VM subject to migration, the VM can be executed on the computer of the migration destination in the entirely same manner as executed before migration. The migration of the VM is basically implemented by copying a logical and physical memory (which is physically seen from the VM but is a physical memory of a logical entity) constituting the VM.

These technologies achieve the integration of a plurality of computers executing in a system into one computer, load balancing by migrating the guest OS in accordance with a load on a computer, higher availability of a computer system by migrating the guest OS during a computer failure, and the like. As an example of allocating a VM to a computer in a system, a method of relocating the VM in accordance with the operating conditions of the computer is described in United States Patent Application 20060069761.

In the virtualization module, there is also a technology for allowing a VM to directly use an I/O device incorporated in a computer (“AMD I/O Virtualization Technology (IOMMU) Specification,” pp. 14, “2.2.5 Virtual Machine Guest Access to Devices,” [online], February 2006 issue, US AMD Corporation, Internet search on Jul. 24, 2006 <URL:http://www.amd.com/us-en/assets/content_type/white_papers_and_tech_docs/34434.pdf>). This makes it possible to similarly configure an I/O device seen from the guest OS on the VM and an I/O device seen from the OS in the case of execution without a virtualization module (by a physical computer).

Further, there is a technology called a network boot of downloading a necessary file from a network upon activation of a computer, thereby activating the computer. As an example of this, U.S. Pat. No. 7,222,229 discloses a method of booting up a computer by a predetermined boot program.

### SUMMARY OF THE INVENTION

Determining freely a host computer that executes a VM has an advantage in increasing the availability of a guest OS and increasing the performance of the guest OS by migration to a host computer having a resource margin.

On the other hand, in order to migrate the VM, a virtualization module needs to be executed in a host computer of a migration destination. In the virtualization of the computer, overhead associated with the virtualization of resources cannot be avoided. Accordingly, in the case of migrating the VM to the host computer executing the virtualization module, there is a problem that the guest OS cannot have higher performance than that of an OS directly executed on the host computer (physical computer). This problem indicates that the performance of the guest OS which can be improved by migration depends on the host computer executing the virtualization module and having the overhead.

With preparation of a host computer (physical computer) having the same hardware configuration as that of the virtual machine, configured by a virtualization module, or LPAR, configured by a logical partition module, the guest OS executed on the VM or LPAR can be executed directly on the host computer, as a matter of logic. That is, a storage (boot storage) referred to upon activation of the guest OS can be used as a storage (boot storage) for use in activating the OS in the host computer. In this case, it is not possible to migrate the guest OS to be directly executed on the host computer without shutting down the guest OS, but it is necessary to shut down the guest OS. Accordingly, there are problems that it takes time to perform shutdown processing for writing data buffered in a memory until migration to the storage, and it takes time to boot and activate the OS including the data.

As a background to the occurrence of these problems, improving the performance of the guest OS by migration has been studied in the virtual machine method in which the host computer executing the VM is determined freely, but there has been no idea of migrating the OS to the host computer (physical computer) without the virtualization module in order to further improve the performance. That is, there has been no idea of migrating the OS between the computer with the virtualization module and the computer without the virtualization module in a computer system in order to further improve the performance or to maintain proper performance.

The present invention provides a method of migration between a virtual machine and a physical computer and a computer system thereof as follows.

Assume that one of a first computer and a second computer has a virtualization module and the other one does not have a virtualization module. In response to a migration instruction, an OS in execution on the first computer is suspended. The contents of a memory area of the first computer used for the OS at the suspend point in time are migrated to a memory area of the second computer. In this migration, a storage area of information indicative of the OS suspend point is included. A memory area management method of the virtualization module between the first computer and the second computer is converted. Then, the second computer resumes OS execution by referring to the information indicative of the suspend point and using the migrated contents of the memory area.

### BRIEF DESCRIPTION OF THE DRAWINGS

FIG. 1 is a diagram showing a system configuration example of a first embodiment.

FIG. 2 is a diagram showing a computer configuration example of the first embodiment.

FIG. 3 is a diagram showing a migration processing flow of the first embodiment.

FIG. 4 is a diagram showing a system configuration example of a second embodiment.

FIG. 5 is a diagram showing a migration processing flow of the second embodiment.

FIG. 6 is a diagram showing a migration processing flow of the second embodiment.

FIG. 7 is a diagram showing a system configuration example of a third embodiment.

FIG. 8 is a diagram showing a migration processing flow of the third embodiment.

### DESCRIPTION OF THE PREFERRED EMBODIMENTS

Description will be made of the best mode for carrying out the invention, in which an OS is migrated from a first computer with a virtualization module to a second computer (physical computer) without a virtualization module by way of example.

First, in response to a migration instruction, an OS in execution on the first computer is suspended. The migration instruction may be a command input by a user (administrator) of a computer system, or may be generated based on the result of monitoring loads on the second computer and each VM of the first computer. In the latter, an entity that monitors the loads or generates the migration instruction may be the first computer, the second computer, or another computer connected to these computers.

In response to the OS suspend, information indicative of the suspend point is stored in a predetermined memory area. The information indicative of the suspend point denotes the contents of a PC (program counter) indicative of the address of an instruction to be executed next. In the case of being executed under the virtualization module, the contents of various registers as well as the PC are controlled to be stored in the predetermined memory area. However, there may be implementation in which the contents of various registers are stored in the predetermined memory area at timing for switching from a VM executing the suspended OS to another VM but storage in sequential memory area is not performed to reduce overhead associated with the storage in the predetermined memory area during operation of the VM executing the suspended OS. Accordingly, it is desirable that the contents of various registers including the PC be stored in the predetermined memory area. The contents of the memory area of the first computer, including the predetermined area and used for the suspended OS, are retained (snapshot). The memory area used for the OS includes the program code area of the OS and areas for various parameters and temporary data.

The contents (snapshot image) of the memory area of the first computer are migrated to a memory area of the second computer. Then, a memory area management method between the first computer and the second computer is converted. More specifically, the migrated contents of registers of the first computer (in reality, used by the VM) stored in the predetermined area are set in the corresponding registers of the second computer. That is, the memory area management method is mainly directed to the conversion between the handling of registers under the virtualization module and the handling of registers under the physical computer and to the conversion of an address that is a reference for accessing the memory area used by the OS.

Thus, the second computer can resume OS execution by referring to the information indicative of the suspend point and using the migrated contents of the memory area.

For the migration of the contents of the memory area of the first computer to the memory area of the second computer, a loader externally reads the OS executed on the second computer into the memory area of the second computer. More specifically, the loader may read through a network for connecting the first computer to the second computer or through an external storage device used for mediating the migration. In the case where the loader reads through the network, the transfer can be achieved either by a pull type based on the loader (receiving side) or by a push type based on the sending side.

The above-described migration is performed between the two computers; however, in the case of a plurality of computers, it is necessary to designate a migration destination. As in the case of the migration instruction, a migration destination may be designated through the use of a command input by a user (administrator) of a computer system, or may be designated based on the result of monitoring loads on the second computer and each VM of the first computer. The designation may be performed after the suspend of the OS to be migrated, or performed at the same time as the migration instruction.

In the above-described best mode, it is desirable to turn off the power of an I/O device in use by the OS to be suspended or not to operate the I/O device, in conjunction with the suspend of the OS in execution on the first computer. That is, it is necessary not to destroy the snapshot memory contents. If the I/O device operates, there is a possibility that the OS receives an interrupt from the I/O device and the interrupt processing program destroys the snapshot memory contents. In order to deal with this phenomenon, though it is not necessary to turn off the power, it is necessary not to destroy the snapshot memory contents in association with the execution of the program. To this end, there is used a method in which an area different from the snapshot memory area is used for a program executed after the snapshot, or a copy-on-write technique of saving the contents before the update into another area in association with the update of the memory contents.

Hereinafter, specific configurations and operations according to the first to third embodiments will be described. While, in the best mode, description has been made of the OS migration from the first computer with a virtualization module to the second computer (physical computer) without a virtualization module, it will be understood through the description of the first to third embodiments that an OS can be easily migrated from the second computer (physical computer) without a virtualization module to the first computer with a virtualization module. Further, it will be understood that migration methods according to the first to third embodiments are reversible methods in which a migration source and a migration destination can be interchanged.

Further, in the method of migrating the OS through the mediation of the external storage device, it will be understood that OSs can be simultaneously migrated (i.e., swapped) between the first computer and the second computer, using mutually different storage areas in the external storage device.

### First Embodiment

In the first embodiment, description will be made of a method for migrating an OS executed on a VM to be directly executed on a physical computer without a shutdown by using the hibernation function of the OS.

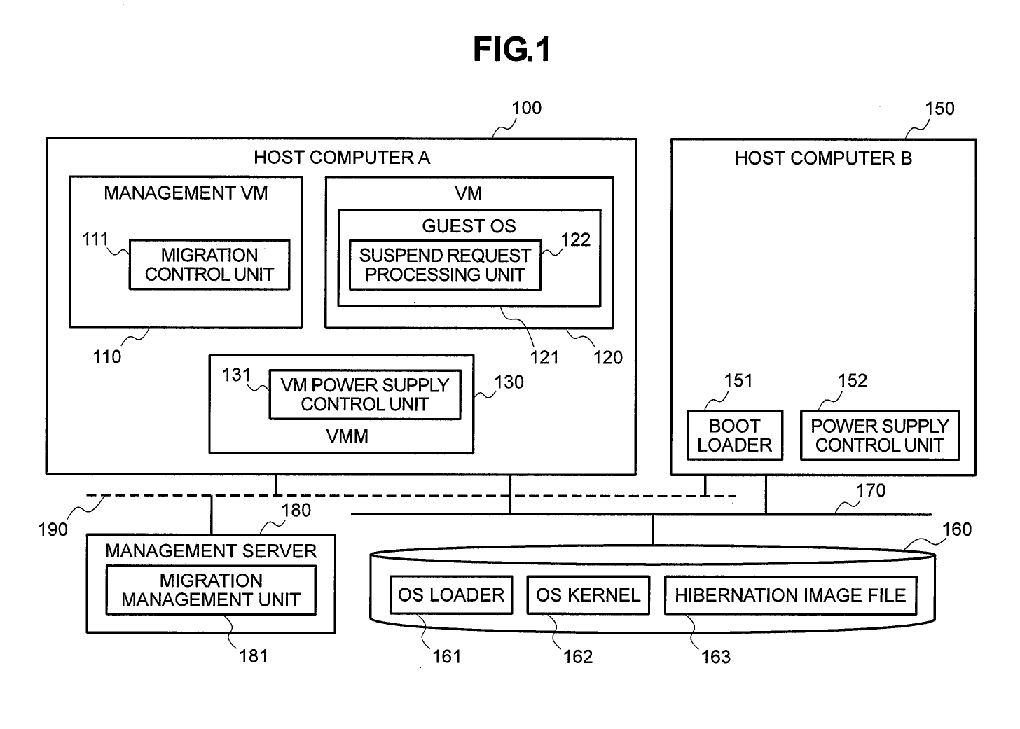

FIG. 1 is a diagram showing a system configuration example of this embodiment. In this embodiment, description will be made of a method for migrating a guest OS 121 executed on a VM 120 in a host computer 100 to be executed on a host computer 150.

A management server 180 executes a migration management unit 181. A user gives a VM migration instruction to the migration management unit 181 to start VM migration. The migration management unit 181 performs migration processing of the VM in cooperation with a migration control unit 111 in a management VM 110 executed on the host computer 100. Further, the management server 180 manages the configuration of the VM executed in the system of FIG. 1 and hardware information on the host computers constituting the system of FIG. 1.

The host computers 100 and 150 and the management server 180 are connected together via a network 190, and can communicate with each other.

The host computer 100 executes a virtualization module VMM 130. The management VM 110 and the VM 120 are executed on the VMM 130. The VM 120 is defined by a user, and executes the guest OS 121 in this example. The guest OS 121 has the function of suspending and resuming the OS by hibernation.

The hibernation is the function of writing the contents of a physical memory at an OS suspend point into an external storage device, reading the memory contents written into the external storage device, and resuming OS execution from the suspend point. In other words, this is the function of taking a snapshot of the physical memory at the OS suspend point into the external storage device and resuming execution from the suspend point based on the snapshot file (image file). In the case where hibernation processing is executed as part of OS processing as in this embodiment, the OS is suspended after hibernation execution; accordingly, there is a possibility that the memory contents is updated from the suspend point of normal processing of the OS (time point before entering the hibernation processing). To avoid this, a different memory area from a memory area subject to the snapshot is used in the hibernation processing, or the copy-on-write technique is used, so that the contents of the memory area subject to the snapshot are not updated.

The physical memory in execution by the OS denotes a memory corresponding to the physical address of a memory area used by the guest OS (seen from the guest OS) including the program area of the guest OS and a memory area used by the VM for the execution by the guest OS (e.g., a memory area emulating a register used by the guest OS). To access these memory areas, a register that stores a reference address (in general, the starting address of the memory area) is used. This register also is emulated by the memory area used by the VM.

Further, the address of an input/output device (I/O address) used by the guest OS also is stored in the memory area used by the VM. In this embodiment, for migration, the same resources need to be prepared in the computer of a migration destination; however, there may be used different addresses and names for using these.

Assume that OS execution is suspended in association with the end of execution of an instruction. The address of an instruction to be executed next is stored in a PC (program counter), and the PC is a kind of register and is emulated by the memory area; accordingly, by setting in the PC the address of the instruction to be executed next which is stored in the memory area, the computer of a migration destination can resume OS execution from the suspend point in time.

The guest OS 121 executes a suspend request processing unit 122 which suspends OS execution by hibernation in accordance with a request from the outside.

The management VM 110 provides an interface for controlling the VMM 130. A guest OS (not shown) is executed also on the management VM 110, and the migration control unit 111 is executed on the guest OS. The migration control unit 111 performs migration processing of the VM 120 in cooperation with the VMM 130, in response to a migration instruction from the migration management unit 181 in the management server 180.

The host computer 150 includes a boot loader 151 executed upon activation of the computer and a power supply control unit 152 for controlling the power supply of the host computer 150 remotely via the network. The power supply control unit 152 can activate the host computer 150 by turning it on, in response to an instruction from the management server 180. The boot loader 151 is a program which is executed upon activation of the computer 150 and incorporated in the host computer 150.

The host computers 100 and 150 are connected to a storage 160 through a storage network 170. The storage 160 includes an OS loader 161, an OS kernel 162, and a hibernation image file 163. In reality, the computers have a disk adapter, and the storage network includes a storage switch and a storage device, though these are omitted here.

The OS loader 161 is read into a memory in the host computer 150 by the boot loader 151 upon activation of the host computer 150, and executed by the CPU. Normally, the OS loader 161 reads the OS kernel 162 into the memory to start OS execution.

In the case where the hibernation image file 163 created by the hibernation function exists in the storage 160, the OS loader 161 reads the hibernation image file 163 into the memory to reconfigure the physical memory to the contents at the hibernation execution, and passes control to the OS so that execution can be resumed from the suspend point of the OS. The OS loader 161 stores beforehand the structure of the hibernation image file 163. More specifically, the OS loader 161 recognizes an area used by the OS and an area in which the contents of various registers are stored.

Reconfiguring the physical memory to the contents at the hibernation execution signifies developing the contents of the area used by the OS onto a memory in the host computer 150 and setting a reference address for access thereof into a predetermined register. Further, the contents of various registers stored in the hibernation image file 163 are set in a corresponding register. Lastly, the suspend point (the address of the instruction to be executed next) stored in the hibernation image file 163 is set in the PC (program counter) in the host computer 150, so that OS execution is resumed on the host computer 150.

The VMM 130 includes a VM power supply control unit 131 for causing the guest OS 121 executed on the VM to start hibernation. The VM power supply control unit 131 sends a virtual interrupt for hibernation instruction to the VM 120. The guest OS 121 executed on the VM 120 receives the virtual interrupt to start hibernation processing. The interrupt by the power supply control is defined in a specification such as the ACPI (Advanced Configuration and Power management Interface).

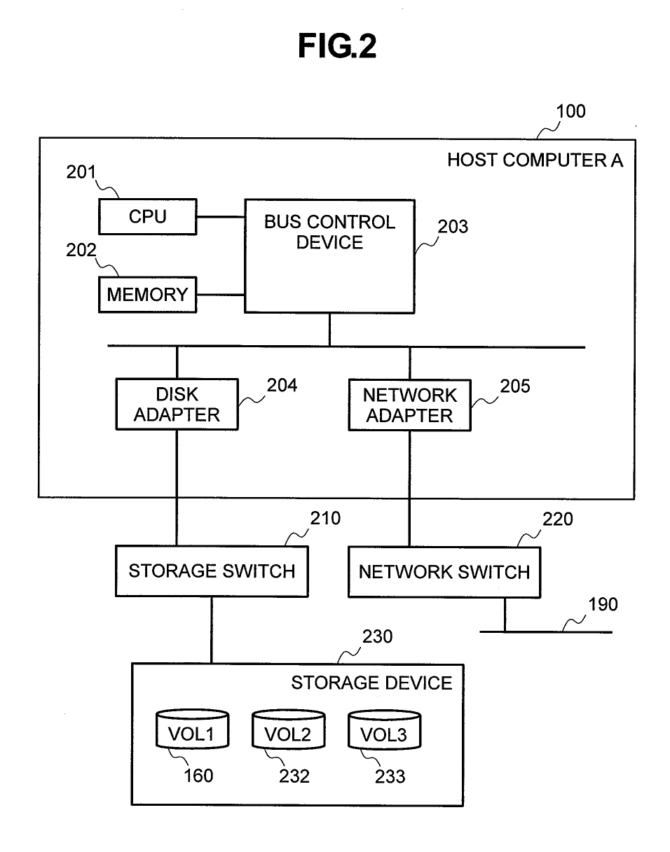

FIG. 2 is a diagram showing a computer configuration example of this embodiment. The computers according to this embodiment have a general configuration. For example, the host computer 100 is composed of a CPU 201, a memory 202, a disk adapter 204, a network adapter 205, and a bus control device 203 for connecting these devices.

The disk adapter 204 is connected to a storage device 230 through a storage switch 210. The storage device 230 can include a logical disk. The storage device 230 includes a storage volume 160 connected to the host computer 100. In FIG. 2, other storage volumes 232 and 233 are shown.

The network adapter 205 can be connected through a network switch 220 to the host computer 150 and the management server 180. The other computer has a similar configuration.

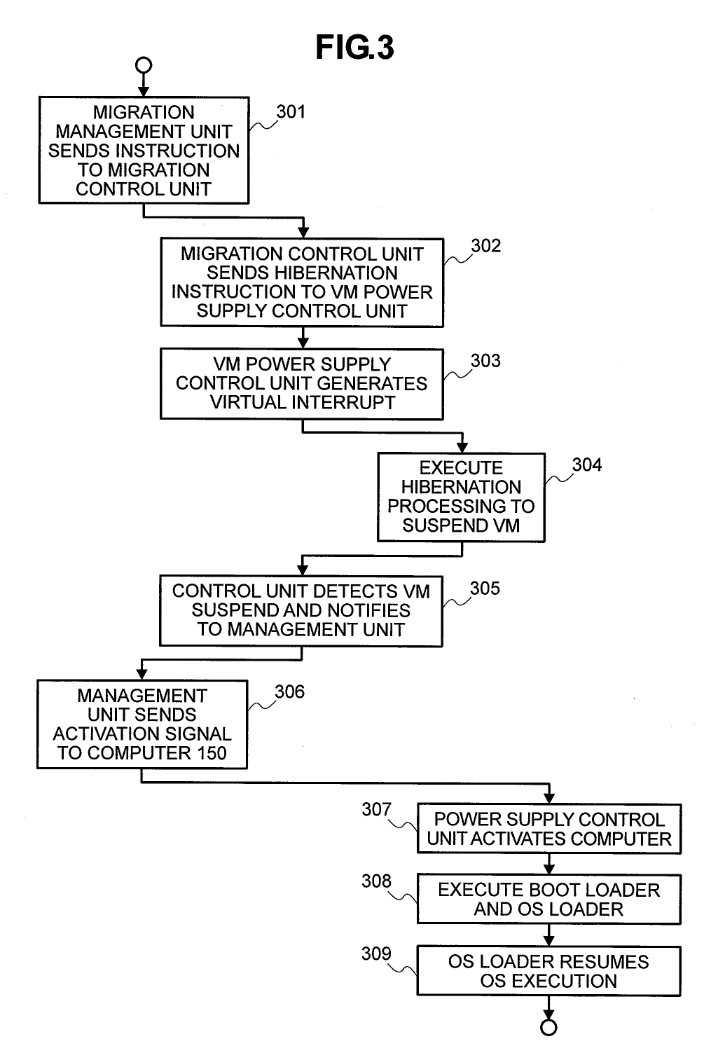

A migration processing flow of this embodiment will be described with reference to FIG. 3. In FIG. 3, there is shown a procedure for migrating the guest OS 121 executed on the VM 120 on the host computer 100 to the host computer 150 and executing the guest OS 121.

A user gives an instruction on migration of the guest OS 121 to the migration management unit 181 in the management server 180. In response thereto, the migration management unit 181 sends the migration instruction to the migration control unit 111 in the host computer 100 which executes the VM 120 subject to migration (step 301). The migration control unit 111 instructs the VM power supply control unit 131 in the VMM 130 to cause the VM 120 to hibernate (step 302). Subsequently, the VM power supply control unit 131 generates a virtual interrupt and sends it to the VM 120 (step 303).

The guest OS 121 executed on the VM 120 receives the sent virtual interrupt, and executes hibernation processing to suspend OS execution (step 304). That is, the guest OS 121 records (takes a snapshot of) the contents of a logical and physical memory of the VM 120 into the hibernation image file 163 of the storage 160, and suspends the execution of the OS as well as the VM 120. The logical and physical memory denotes a memory that is physically seen from the VM 120 but is actually a logical memory; therefore, it is a physical memory as an entity thereof.

In FIG. 3, the VM 120 is suspended by sending the virtual interrupt to the guest OS 121; however, the guest OS 121 may hibernate by processing on the guest OS 121 in response to a request sent to the suspend request processing unit 122 executed on the guest OS 121.

Upon detecting the suspend of the VM 120, the migration control unit 111 notifies this suspend to the migration management unit 181 (step 305). In response thereto, the migration management unit 181 sends an activation signal to the host computer 150 which is the migration destination of the guest OS (step 306). There are various implementation methods for activating the host computer 150 from the network. It is possible to implement a method of incorporating in the computer a network adapter that responds to a packet of a particular form for power supply control or a method of incorporating a device specific to remote power supply operation beforehand. In this embodiment, the power supply control unit 152 which receives control from the network is incorporated in the host computer 150.

Upon receiving the activation signal, the power supply control unit 152 in the host computer 150 activates the host computer 150 (step 307). The host computer 150 executes the boot loader 151, and the boot loader 151 reads the OS loader 161 into the memory to execute it (step 308).

The OS loader 161 detects the hibernation image file 163 in the storage 160, and writes data stored in the file 163 into the memory, as memory contents at the suspend point of the guest OS 121. After recovering the memory contents, the OS loader 161 passes control to the OS 121 so that execution can be resumed from the suspend point of the guest OS 121 (step 309). The recovery of the memory contents and the resumption of execution from the suspend point of the guest OS 121 are performed as described above.

Thus, it is possible to migrate the guest OS 121 executed on the VM 120 to be directly executed on the host computer 150 without shutting down the guest OS 121.

Thereby, it is possible to execute the OS 121 on the host computer 150 continuously without discarding data etc. stored in the memory by the execution of the guest OS 121. In the case where an application such as a database using a memory as a cache is executed on the OS 121, the cache can be used continuously after migration, which advantageously does not cause a temporary degradation in performance of the computer executing the OS after the change.

In the case where it takes time to shut down the OS 121 and perform activation processing, since it is possible to avoid these processes by hibernation, there is an advantage that the service suspend time can be reduced.

In this embodiment, the migration from the VM to the physical computer has been described; however, reverse migration also can be performed. That is, it is possible to suspend the OS directly executed on the physical computer by hibernation, activate the virtual machine having the same configuration as the computer, and resume OS execution from the hibernation image file 163. In this case, in response to an instruction from the migration management unit 181, the suspend request processing unit 122 executed on the OS causes the OS to hibernate. The VM can be generated and activated through an interface provided by the management VM 110.

### Second Embodiment

The second embodiment will be described. In this embodiment, description will be made of a method for migrating the execution of the guest OS on the VM to a physical computer without using the hibernation function of the OS.

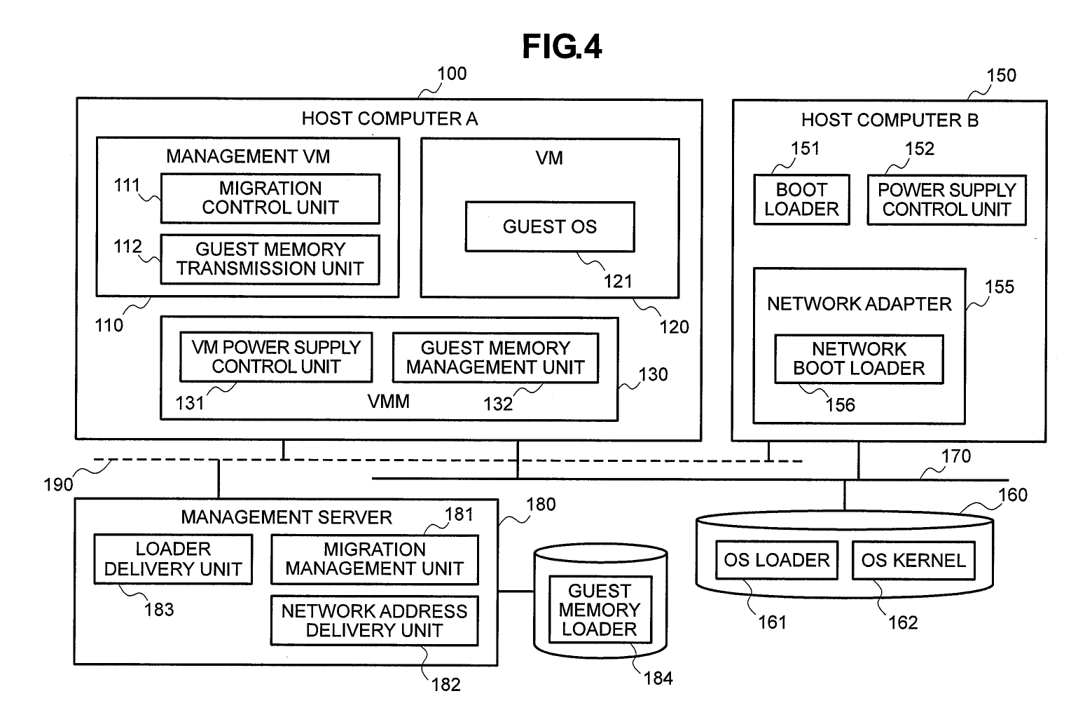

FIG. 4 is a diagram showing a system configuration example of this embodiment. While the configuration shown in FIG. 4 is similar to that of FIG. 1, additional constituent units will be described below.

The VMM 130 has a guest memory management unit 132. The guest memory management unit 132 manages a logical and physical memory allocated to the VM in execution, and provides an interface for accessing the contents. In addition, the management VM 110 executes a guest memory transmission unit 112. In response to a request via the network, the guest memory transmission unit 112 extracts the contents of the logical and physical memory of the VM 120 through the use of the interface of the guest memory management unit 132, and sends it to a request source.

The host computer 150 has a network adapter 155 equipped with a network boot loader 156. The network boot loader 156 is invoked in the process of activating the host computer 150, and acquires a program such as an OS loader necessary for OS activation and parameters, files, etc. necessary for activation processing from the server on the network to activate the computer. It is determined by the setting of the computer 150 whether the computer 150 is activated by the network boot loader 156 or the boot loader 151. PXE (Pre-Boot Execution Environment) is a typical example of implementing a network boot module.

In the management server 180, a network address delivery unit 182 and a loader delivery unit 183 are executed. In response to a request from the computer, the network address delivery unit 182 delivers a network address available for the computer. In this embodiment, upon activation of the computer 150, the network adapter 155 requests an address from the network address delivery unit 182. DHCP (Dynamic Host Configuration Protocol) is a typical example of implementing such address assignment.

The loader delivery unit 183 is a program for delivering a program, a parameter, a file, etc. for activating the computer, in response to a request from the network boot loader 156. For example, the loader delivery unit 183 delivers a guest memory loader 184 stored in the storage 160 connected to the management server 180, as a file for activating the host computer 150.

In this embodiment, these additional units work cooperatively to migrate the guest OS 121 to be directly executed on the host computer 150 without a shutdown.

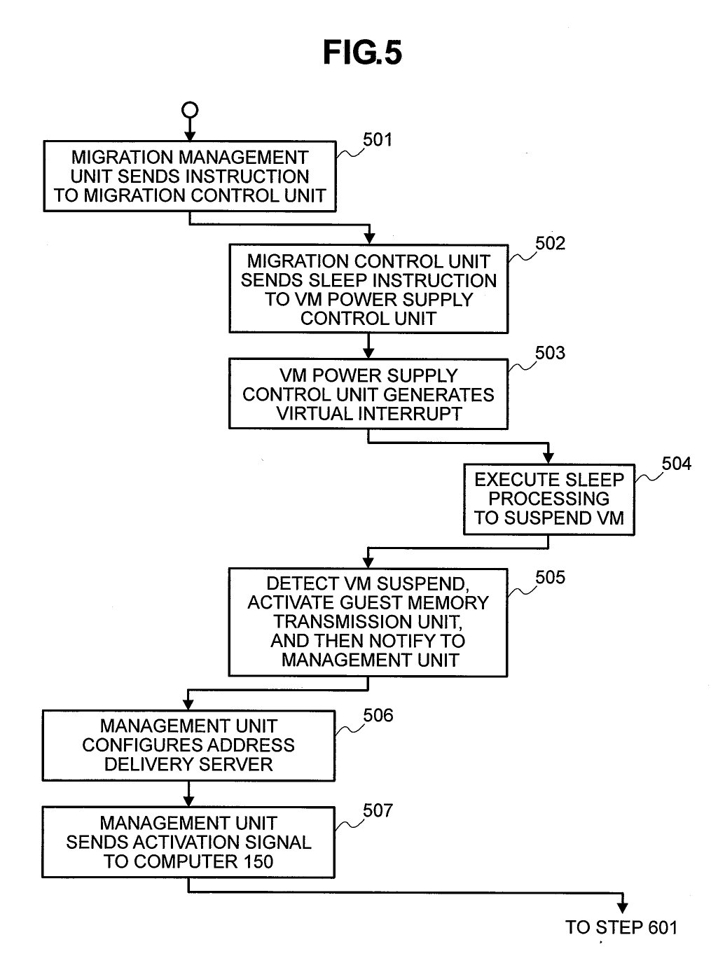

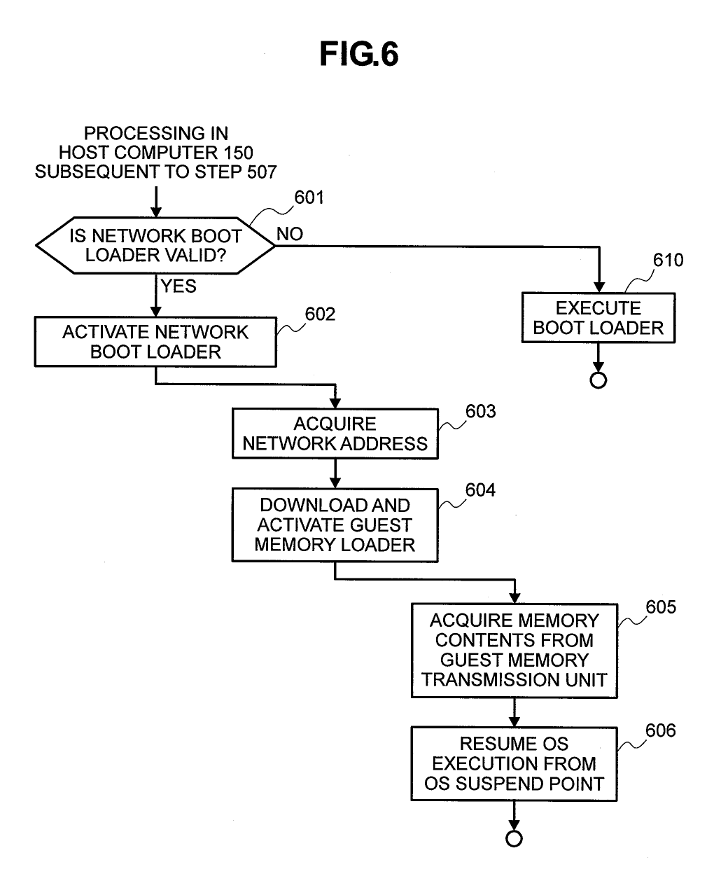

A migration processing flow of this embodiment will be described with reference to FIGS. 5 and 6.

FIG. 5 shows a flow between receiving a migration instruction from a user and sending an activation signal to the host computer of a migration destination. This is almost the same as the flow of FIG. 3 according to the first embodiment. The description of the same processing is omitted, and different processing will be described below.

The VM power supply control unit 131 sends, to the VM 120, a virtual interrupt for activating sleep processing, not a virtual interrupt for activating hibernation processing (steps 502 and 503).

The sleep processing suspends OS execution while holding memory contents, and corresponds to the S3 state defined by the ACPI (Advanced Configuration and Power management Interface). In the S3 state, the power of an I/O device incorporated in the computer is turned off, and the execution of the CPU is suspended in a state of holding memory contents. In the sleep processing, the address of an instruction for starting execution of the CPU at the time of resumption from a sleep state is registered to a predetermined address in the memory before suspending the CPU.

When the guest OS 121 receives the virtual interrupt for specifying a transition to the S3 state, the guest OS 121 executes the sleep processing to suspend the execution of the guest OS. At this time, the VM also transitions to a suspend state (step 504).

Upon detecting the suspend of the VM, the migration control unit 111 activates the guest memory transmission unit 112 to be ready for an acquisition request for the contents of the logical and physical memory of the VM 120, and then notifies the suspend of the VM 120 to the migration management unit 181 in the management server 180 (step 505).

Upon receiving the notification, the migration management unit 181 configures the network address delivery unit 182 (step 506), and sends an activation signal to the host computer 150 of a migration destination (step 507). In the configuration in step 506, responding to a request from the host computer 150 is set, and an address for communicating with the VM 110 in the host computer 100 of the migration source is registered as the address of the guest memory transmission unit 112. In order that the address delivery unit 182 can determine whether the request is one from the host computer 150, for example, the MAC address of the network adapter 155 incorporated in the host computer can be registered.

FIG. 6 shows the subsequent processing flow of the host computer 150. The activated host computer 150 checks whether the setting of the network boot loader 156 is valid in activation processing (step 601). If the setting is not valid, the normal boot loader 151 activates the computer (step 610). In this embodiment, the network boot loader 156 is set to be valid.

If the setting is valid, the network boot loader 156 is activated (step 602). The network boot loader 156 acquires a network address to be used in boot processing from the network address delivery unit 182 (step 603).

More specifically, the network boot loader 156 broadcasts an address acquisition request to the network. Upon receiving the broadcast address request, the address delivery unit 182 determines whether to respond to the request. If the address delivery unit 182 responds to the request, the address delivery unit 182 sends a network address used by the host computer 150, the address of a computer that accepts the delivery processing of a loader program, and the address of a computer that processes a request to deliver guest memory contents, to the network boot loader 156 of the request source. Since the address of the guest memory delivery source is registered in step 506, it is the address for connecting to the management VM 110 in the host computer 100. In this embodiment, the acquisition destination address of the loader program is the address of the management server 180.

If the address delivery unit 182 does not respond to the request, the network boot loader 156 ends request waiting due to timeout, and the host computer 150 is activated by the normal boot loader 151.

Then, the guest memory loader 184 is downloaded from the computer having the acquisition destination address of the acquired loader program and executed (step 604). In this embodiment, the loader program is managed by the management server 180 and delivered by the loader delivery unit 183 in response to a request from the network boot loader 156.

The guest memory loader 184 acquires the contents of the guest memory from the address of the guest memory request destination which is delivered by the address delivery unit 182 (step 605). More specifically, the guest memory loader 184 requests the guest memory transmission unit 112 to acquire the memory contents of the VM suspending in a sleep state. The guest memory transmission unit 112 acquires the memory contents from the guest memory management unit 132 in the VMM 130 and transmits the memory contents.

The guest memory loader 184 acquires the memory contents from the guest memory transmission unit 112. The guest memory loader 184 reproduces, in memories used by the OS, the contents at the suspend point of the guest OS 121, and passes control to the OS so that OS execution can be resumed from the suspend point of the OS (step 606). The way to pass control is the same as the way to resume from S3 in the ACPI.

Thus, it is possible to resume OS execution on the physical computer without shutting down the guest OS executed on the virtual machine. Unlike the case of hibernation, it is not necessary to store a hibernation file in the storage used by the OS.

Since the boot loader 151 and the network boot loader 156 are programs incorporated in the computer or the network adapter, it is difficult to change them in accordance with a use environment. However, since the guest memory loader 184 which is executed by download can be an arbitrary program, control according to a system environment can be performed for migration.

In this embodiment, an activation signal is sent to the host computer of the migration destination after the VM is put in a suspend (sleep) state; however, the activation signal may be sent at the time of start of migration control. In this case, the guest memory loader 184 is executed to acquire the memory contents in synchronization with the guest memory transmission unit 112.

In this embodiment, the guest memory loader 184 loaded by the network boot loader 156 incorporated in the network adapter 155 copies the memory contents; however, a program for copying the memory contents is not limited thereto, but may be a program loaded from the storage.

### Third Embodiment

The third embodiment will be described. In this embodiment, description will be made of a method for migrating an OS executed on a physical computer to a virtual machine without shutting down the OS. The description is directed to a method for acquiring memory contents during the sleep of the OS in the same way as in the second embodiment thereby to configure the memory of the VM, and more specifically, to a method for acquiring the memory contents in cooperation with the internal processing of the OS.

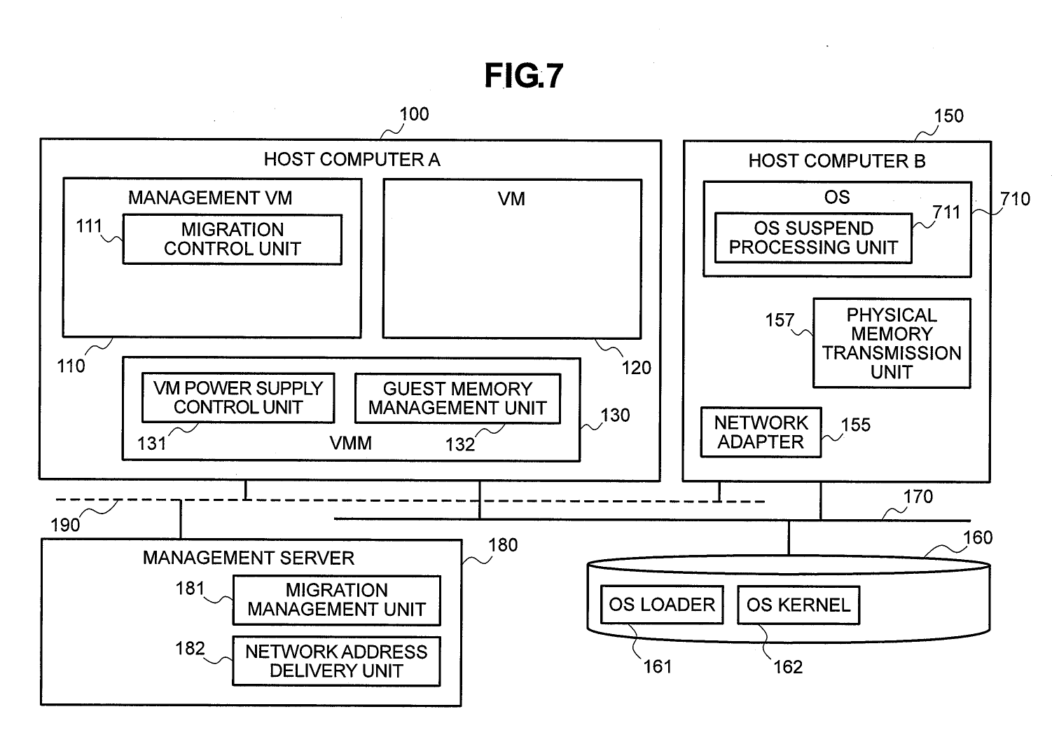

FIG. 7 is a diagram showing a system configuration example of this embodiment. Description will be made of a method for migrating an OS 710 executed on the host computer 150 to be executed in the VM on the VMM 130 in the host computer 100.

The system configuration shown in this embodiment is similar to those of FIGS. 1 and 2. Constituent units specific to this embodiment will be described below.

The OS 710 executed on the host computer 150 is an OS subject to migration. The OS 710 implements an OS suspend processing unit 711. The OS suspend processing unit 711 suspends OS execution by processing similar to the above-described sleep processing, but executes the delivery processing of physical memory contents without suspending the CPU.

The host computer 150 has a physical memory delivery unit 157 as firmware. This is executable even during the suspend of execution of the OS 710, and the network adapter 155 executes the processing for delivering the physical memory contents.

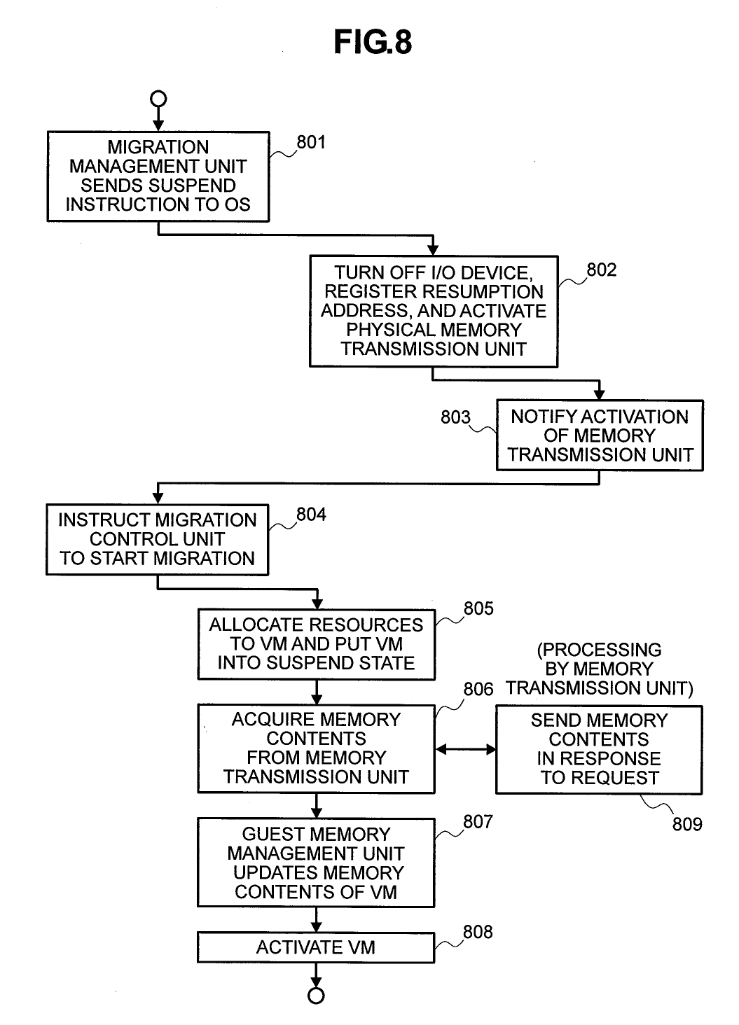

A migration processing flow of this embodiment will be described with reference to FIG. 8.

The migration management unit 181 instructs the OS 710 subject to migration to suspend the OS (step 801). The suspend processing unit 711 in the OS 710 turns off the power of an I/O device incorporated in the host computer 150, and registers an execution resumption address into a memory. Then, the suspend processing unit 711 activates the physical memory transmission unit of the firmware (step 802). At this time, the suspend processing unit 711 also notifies the address of the management server 180 to the physical memory transmission unit 157.

The physical memory transmission unit 157 is executable independently of the OS even if the OS is not executed. The physical memory transmission unit 157 notifies the migration management unit 181 in the management server 180 that it is ready for delivery processing (step 803).

Upon receiving the notification, the migration management unit 181 instructs the migration control unit 111 in the management VM 110 executed on the host computer 100 of a migration destination to start migration (step 804). At this time, the migration management unit 181 also notifies the address of the host computer of a migration source.

The migration control unit 111 assigns the VM 120 having the same resources as the host computer 150 of the migration source (step 805). The assigned VM 120 is put in a suspend state.

Then, the migration control unit 111 acquires physical memory contents from the physical memory transmission unit 157 in the host computer 150 of the migration source (steps 806 and 809), and the guest memory management unit 132 updates a memory constituting the VM 120 (step 807). It will be easily understood that this processing is the reverse of the processing in the first embodiment. That is, in order to update the memory constituting the VM 120, it is necessary to transfer, to the memory of the migration destination, the contents of various registers as well as the contents of the physical memory in the host computer 150 of the migration source. The contents of various registers are registered into the memory concurrently when the execution resumption address is registered into the memory in step 802, so that these are transferred to the memory of the migration destination.

After the update of the memory contents, the migration control unit 111 activates the VM 120 (step 808). Upon activation, the VM 120 moves control to the resumption address registered before the OS suspend to resume execution of the OS 121.

Thus, it is possible to migrate the OS executed on the physical computer to be executed on the VM of the virtualization module without a shutdown. In the first embodiment, the OS can be migrated from the physical computer to the virtual machine by using the hibernation function of the OS. Similarly, the OS executed on the physical computer can be migrated to the virtual machine without shutting down the OS. This embodiment has the advantage that there is no need to store a hibernation image file in the storage due to no use of hibernation.

According to the invention, it is possible to reduce the time required to shut down the OS in the computer of the migration source and the time required to activate the OS in the computer of the migration destination, thereby reducing the service suspend time.

What is claimed is:

1. A method of OS migration between a first computer and a second computer, one of the first computer and the second computer being provided with a virtualization module and the other one not being provided with a virtualization module, the OS migration method comprising the steps of:
suspending an OS in execution on the first computer, in response to a migration instruction;
migrating a content of a memory area of the first computer, including a storage area of information indicative of a suspend point and used for the OS at the suspend point, to a memory area of the second computer;
converting a memory area management information of the virtualization module between the first computer and the second computer; and
resuming execution of the OS by referring to the information indicative of the suspend point and using the migrated content of the memory area by the second computer.

2. The OS migration method according to claim 1, wherein for migration of the content of the memory area of the first computer to the memory area of the second computer, a loader externally reads the OS executed on the second computer into the memory area of the second computer.

3. The OS migration method according to claim 2, wherein after suspend of the OS in execution on the first computer, the migration of the content of the memory area of the first computer to the memory area of the second computer is started in response to an instruction for specifying the second computer as a migration destination.

4. The OS migration method according to claim 3, wherein for the migration of the content of the memory area of the first computer to the memory area of the second computer, the loader reads the content of the memory area of the first computer into the memory area of the second computer through a network for connecting the first computer to the second computer.

5. The OS migration method according to claim 4, wherein the second computer downloads the loader to the second computer from a third computer connected to the network.

6. The OS migration method according to claim 4, wherein the first computer transfers the content of the memory area of the first computer to the second computer through the network, in response to a request from the loader.

7. The OS migration method according to claim 6, wherein the loader has a network address, as a parameter, of a transfer source for transferring the content of the memory area of the first computer.

8. The OS migration method according to claim 3, wherein for the migration of the content of the memory area of the first computer to the memory area of the second computer, the loader reads the content of the memory area of the first computer stored in an external storage device by the first computer into the memory area of the second computer.

9. The OS migration method according to claim 3, wherein in conjunction with the suspend of the OS in execution on the first computer, the power of an I/O device in use by the OS to be suspended is turned off.

10. A computer system which migrates an OS, comprising:
a first computer, having a virtualization module, which suspends an OS in execution under the virtualization module in response to a migration instruction and takes a snapshot of a content of a memory area including a storage area of information indicative of a suspend point and used for the OS at the suspend point; and
a second computer, connected to the first computer, which migrates the snapshot content of the memory area of the first computer to a memory area, sets a content of an area used by the OS to emulate a register to a corresponding register in the memory area of a migration destination, refers to the information indicative of the suspend point, and resumes execution of the OS, using the migrated content of the memory area.

11. The computer system which migrates an OS, according to claim 10, wherein the second computer has a loader for externally reading the OS executed on the second computer, and the loader reads the content of the memory area of the first computer into the memory area of the second computer.

12. The computer system which migrates an OS, according to claim 11, wherein after suspend of the OS in execution on the first computer, the loader starts to read the content of the memory area of the first computer into the memory area of the second computer, in response to an instruction for specifying the second computer as a migration destination.

13. The computer system which migrates an OS, according to claim 12, wherein there is provided a network for connecting the first computer to the second computer, and the loader reads the content of the memory area of the first computer into the memory area of the second computer through the network.

14. The computer system which migrates an OS, according to claim 12, wherein the loader reads the snapshot content of the memory area of the first computer stored in an external storage device by the first computer into the memory area of the second computer.

15. The computer system which migrates an OS, according to claim 12, wherein in conjunction with the suspend of the OS in execution on the first computer, the power of an I/O device in use by the OS to be suspended is turned off.

16. A computer system which migrates an OS, comprising:
a first computer, operating as a physical computer, which suspends an OS in execution in response to a migration instruction and takes a snapshot of a content of a register and memory area including a storage area of information indicative of a suspend point and used for the OS at the suspend point; and
a second computer, connected to the first computer, which migrates the snapshot content of the register and memory area of the first computer to a memory area, refers to the information indicative of the suspend point, and resumes execution of the OS under a virtualization module, using the migrated content of the memory area.

17. The computer system which migrates an OS, according to claim 16, wherein the second computer has a loader for externally reading the OS executed on the second computer, and the loader reads the content of the memory area of the first computer into the memory area of the second computer.

18. The computer system which migrates an OS, according to claim 17, wherein after suspend of the OS in execution on the first computer, the loader starts to read the content of the register and memory area of the first computer into the memory area of the second computer, in response to an instruction for specifying the second computer as a migration destination.

19. The computer system which migrates an OS, according to claim 18, wherein the loader reads the snapshot content of the memory area of the first computer stored in an external storage device by the first computer into the memory area of the second computer.

20. The computer system which migrates an OS, according to claim 18, wherein in conjunction with the suspend of the OS in execution on the first computer, the power of an I/O device in use by the OS to be suspended is turned off.
